(19) United States
(12) Patent Application Publication
(10) Pub. No.: US 2013/0341909 A1
(43) Pub. Date: Dec. 26, 2013

(54) Crescent Shaped Hose or Hose Adapter

(71) Applicant: Edward A. Chilcoat, Columbus, OH (US)

(72) Inventor: Edward A. Chilcoat, Columbus, OH (US)

(21) Appl. No.: 14/003,029

(22) PCT Filed: Mar. 16, 2012
(86) PCT No.: PCT/US12/00148

§ 371 Date: Sep. 4, 2013

Related U.S. Application Data
(60) Provisional application No. 61/465,267, filed on Mar. 16, 2011.

(51) Int. Cl. F16L 31/00

(52) U.S. Cl. CPC F16L 31/00
USPC 285/125.1; 285/328

(57) ABSTRACT

A crescent shaped hose end or adapter for interfitting into a crescent shaped opening that is formed in a circular opening of a conduit when another circular hose is present in the circular opening of the conduit. In one embodiment, there is an adapter that has a circular end to be affixed to a discharge drain for an appliance and the other end has a crescent shape cross section for use in a drain conduit having a circular opening and alongside another circular hose the takes up space in the opening. In either case, the crescent shaped cross section enables the device to be inserted through a crescent shaped opening that is formed between a circular hose and the circular opening of a drain conduit.

### FIELD OF THE INVENTION

The present invention relates to the field of hose connections, and, more particularly, to a specially designed crescent shaped hose end for connecting a hose to a similarly shaped opening in a receiving conduit.

### BACKGROUND OF THE INVENTION

There are many instances where a hose is intended to be connected to a circular receptacle conduit where the circular opening of the conduit already has a hose present therein. As such, the opening space that is available for a second hose is basically a crescent shape and that shape of opening can not accommodate a normal hose with a circular cross section. There is, therefore, a problem with the connection of a second hose to that conduit due simply to the configuration of the space that is available to introduce the second hose into the already predominately occupied conduit opening.

A prime example of this problem is in the adding of a second hose into a laundry drain conduit. Adding a second drain conduit to accommodate a second discharge line requires costly additional plumbing, especially when retrofitting existing construction. The normal circular discharge hose for a washer normally fills the bulk of the available space in the circular opening in the drain conduit. To add an additional hose, for example, for a condensate drain, as from a condensing dryer, or a discharge hose from some other water source is not possible due to the shape of the space that is available in the opening of the circular drain conduit to accommodate a further hose.

If a second, circular hose is used, that is, two circular hoses inserted through the circular opening in a conduit, there is a considerable unused space such that the conduit must be larger than needed, or space permits, or the circular hoses need to be smaller than is efficient to utilize the space available in a circular conduit.

An example of a semi-circular drain is shown and described in U.S. Pat. No. 8,020,581 of Julian et al, however that configuration is not intended to be located at the end of a hose and is not configured so as to actually penetrate through the circular opening in a conduit alongside a circular hose. The application of the Julian et al invention is for laundry hookup boxes that are different and more complex than industry standards and therefore require costly retrofitting in existing construction.

Accordingly, it would be advantageous to have a specially designed hose or fitting at the end of a hose that can be introduced into the limited crescent shaped space available in a circular conduit alongside a circular hose present in that same conduit opening.

It would also be advantageous to be able to work with existing conventional plumbing standards without modification resulting in reduced costs and installation times.

### BRIEF SUMMARY OF THE INVENTION

The present invention is, therefore, utilized to connect a second hose into the crescent shaped opening that is formed intermediate of a circular hose and the circular opening of a conduit. The present invention is a hose having an end that has a crescent shaped cross section and the crescent shape may be formed in the hose itself or may be an adapter or fitting that is secured to the end of a normal circular hose. In addition, the present hose end or fitting may be straight, arcuate or angled with respect to the hose.

As described herein, the term hose is used, however, it will be seen that the term may include a conduit, pipe constructed of a flexible or non-flexible material. As also used herein, the exemplary embodiment is described with respect to the handling of a liquid and, again, the present invention may be equally applicable to the handling or discharge of a gas in one or both of the hoses or pipes that combine to discharge that gas or gases into a single conduit.

The crescent shape used herein is a quarter moon configuration that is generally, but not necessarily, arcuate of less than 180 degrees and which has an outer wall and an inner wall. Normally, the outer wall has a radius that is larger than the radius of the inner wall, however, it may be that both radii are the same and have a common center point.

Other features of the present crescent shaped hose end or adapter will become more apparent in light of the following detailed description of a preferred embodiment thereof and as illustrated in the accompanying drawings.

### BRIEF DESCRIPTION OF THE DRAWINGS

FIG. 1 is cross sectional view illustrating a conduit in which there is a circular hose located therein, leaving a crescent shaped open area;

FIG. 2 a cross sectional view of the conduit of FIG. 1 with a hose end inserted into the crescent shaped open area of the conduit;

FIGS. 3A-3C are a distal end view, a side vies and a proximal end view of an exemplary embodiment of a hose end constructed in accordance with the present invention,

FIGS. 4A-4C are a distal end view, a side view and a proximal end view, respectively, of an exemplary embodiment of the present invention;

FIGS. 5A-5C are a distal end view, a side view and a proximal end view respectively, of an adapter incorporating the present invention;

FIGS. 6 and 6A are a side view and a cross-sectional view, respectively, of a system using the present invention.

### DETAILED DESCRIPTION OF THE INVENTION

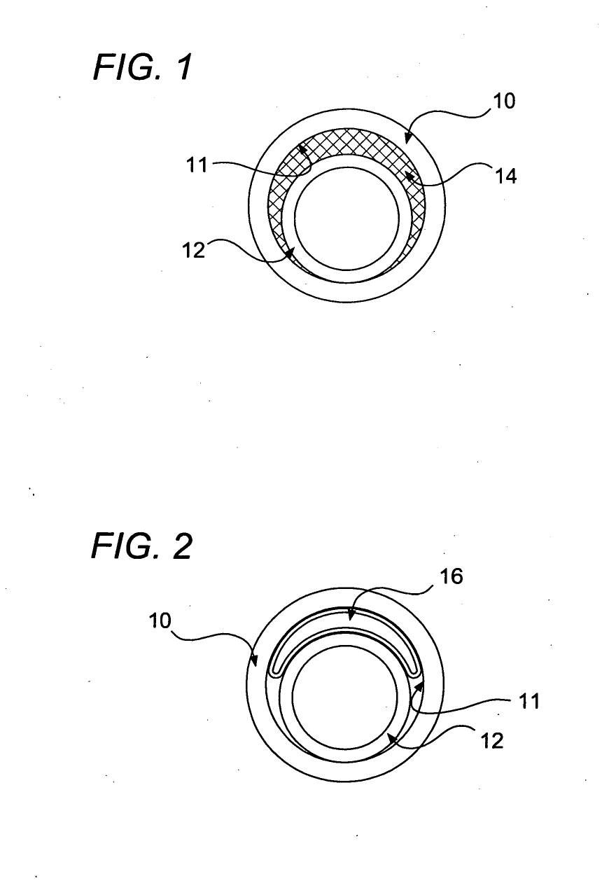

In FIG. 1, there is shown a cross sectional view illustrating a conduit 10 having a circular opening 11 in which there is a circular hose 12 located therein. As can be seen, the presence of the circular hose 12 leaves an open space 14 that is unoccupied by the circular hose 12 and is, therefore, available for some other hose to jointly make use of or share the circular opening 11 in the conduit 10. The open space 14 takes the configuration of a crescent shape.

Turning now to FIG. 2, taken along with FIG. 1, there is shown a cross sectional view of the conduit 10 of FIG. 1 with the circular hose 12 located therein and passing through the circular opening 11. As also can be seen, a second, crescent shaped hose 16 has been inserted into the open space 14 so that both the circular hose 12 and the crescent shaped hose 16 both penetrate through the circular opening 11 in the conduit 10 so as to discharge a material, such as a liquid, into that conduit 10.

As can be seen, the crescent shaped hose 16 can take up all of the open space 14 or can take only a portion of the open space 14 so as to allow a vacuum break to be formed in unoccupied space.

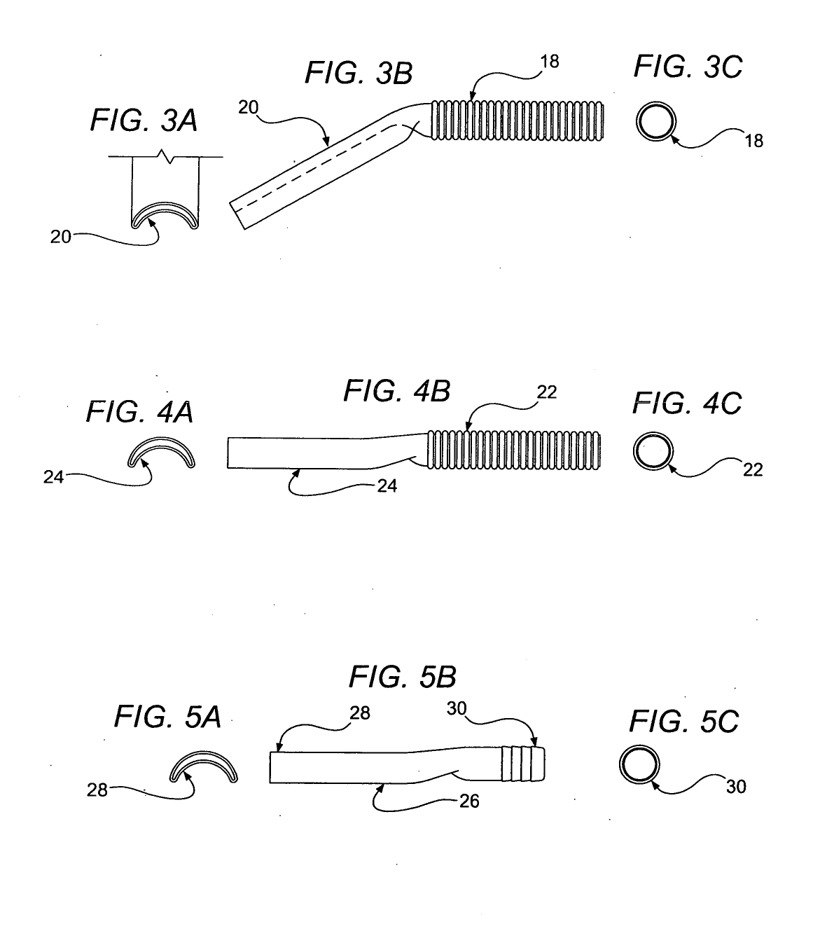

Taking next FIGS. 3A, 3B and 3C, there is shown a distal end view, a side view and a proximal end view, respectively of a circular hose 18 having a distal end 20 that has a crescent shaped cross section and may be a molded plastic construction. As can be seen in this embodiment, the crescent shaped end 20 is formed at an acute angle to the horizontal axis of the circular hose 18.

Next, in FIGS. 4A, 4B and 4C, there is a shown a distal end view, a side view and a proximal end view of a further exemplary embodiment of the present invention. Again, it can be seen that the hose 22 has a crescent shaped distal end 24 and which may be a plastic molded construction extending from the hose 22.

The circular cross section of the hose 22 is shown in FIG. 4C and the cross section of the crescent shaped distal end 24 is shown in FIG. 4A. In this embodiment, the distal end 24 extends so as to be generally in alignment with the longitudinal axis of the hose 22.

Turning then to FIGS. 5A-5C, there is shown an distal end view, a side view and a proximal end view, respectively, of an adapter 26 that incorporates the present invention and which has a distal end 28 and a proximal end 30. The proximal end 30 is a circular cross section and is adapted to be dimensioned so as to fit over or within a hose so that the adapter 26 can be readily affixed to the end of a circular hose, such as a drain hose. The distal end 28 is, again, a crescent shaped cross section and the adapter 26 can be a molded plastic construction or other material.

Accordingly, the adapter 26 can be simply affixed to the end of a standard washing machine circular drain hose or other hose and adapt that hose to have a distal end 28 with a crescent shape cross section so that the drain hose can be inserted into the crescent shaped opening of a circular drain conduit alongside a circular hose as previously explained and make efficient use of the available space in the conduit opening.

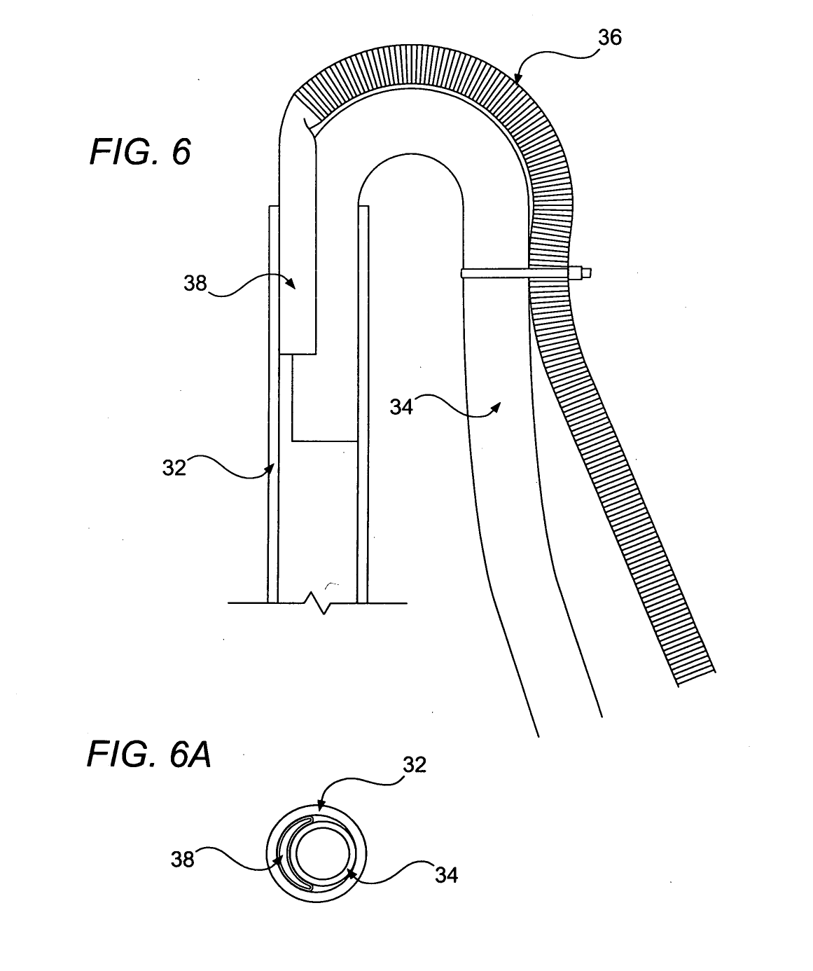

Finally, turning to FIGS. 6 and 6A, there is shown a side view and cross-sectional view, respectively, of a system using the present invention. As such, there is a circular discharge conduit 32 into which there is a circular hose 34 such as a drain from a washing machine or similar apparatus. A second, circular hose 36 is present and which has a crescent shaped end 38 that extends downwardly into the circular conduit 32 to occupy the space that is formed between the circular hose 34 and the circular conduit 32.

Thus, the crescent shaped end 38 allows both hoses to discharge liquids into the circular conduit 32 and thus saving the need to install a second conduit or more elaborate separate discharge system to accommodate the discharge of a liquid or other material through separate hoses.

While the present invention has been set forth in terms of a specific embodiment or embodiments, it will be understood that the crescent shaped hose ends herein disclosed may be modified or altered by those skilled in the art to other configurations. Accordingly, the invention is to be broadly construed and limited only by the scope and spirit of the claims appended hereto.

What is claimed is:

1. A hose adapter adapted to be connected to a circular hose to connect the circular hose to a conduit having a circular opening, the hose adapter having a distal end and a proximal end, the proximal end having a circular cross section for attachment to a circular hose and the distal end having a crescent shaped cross section adapted to enter into the circular opening in the conduit in a crescent shaped space formed between a circular tube positioned in the circular opening of the conduit and the circular conduit.

2. The hose adapter of claim 1 wherein the hose adapter is comprised of a molded plastic.

3. The hose adapter of claim 1 wherein the proximal end is dimensioned so as to interfit with a standard washing machine drain hose.

4. The hose adapter of claim 1 wherein the adapter is angular forming an acute angle.

5. A system for discharging separate flows into a conduit having a circular opening, the system comprising a first, circular hose positioned to enter the circular opening in the conduit leaving a crescent shaped opening in the circular opening of the conduit intermediate the circular hose and the conduit and a second, crescent shaped hose passing through the crescent shaped opening in the circular opening of the conduit.

6. The system of claim 5 wherein the conduit is a drain and the first, circular hose carries water from a laundry apparatus and the second, crescent shaped hose carries a separate stream of water.

7. The system of claim 5 wherein the second crescent shaped hose is comprised of a molded plastic construction.

8. The system of claim 5 wherein the crescent shaped hose comprises a crescent shaped molded end of a circular drain hose.

9. The system of claim 8 wherein the crescent shaped molded end is angled at an angle with respect to a longitudinal axis of the circular drain hose.

10. The system of claim 8 wherein the angle is an acute angle.

11. The system of claim 5 wherein the first, circular hose is a drain hose for a washing machine.

12. The system of claim 11 wherein the conduit is a drain conduit for a washing machine.

13. A hose for transporting a fluid into a circular conduit, the hose having a distal end formed in the shape of a crescent cross section adapted to interfit through a crescent shape opening in the circular conduit intermediate a circular hose and the circular conduit.

14. The hose of claim 10 wherein the distal end is a plastic molded construction.

15. The hose of claim 10 wherein the distal end is formed at an angle to the longitudinal axis of the hose.
